(19) United States
(12) Patent Application Publication
(10) Pub. No.: US 2009/0215449 A1
(43) Pub. Date: Aug. 27, 2009

(54) System and Method for Virtual Roaming of Mobile Communication Devices

(76) Inventor: Netanel Avner, Mevesseret Zion (IL)

Correspondence Address: DR. D. GRAESER LTD., 9003 FLORIN WAY, UPPER MARLBORO, MD, 20772, US

(21) Appl. No.: 12/393,193

(22) Filed: Feb. 26, 2009

Related U.S. Application Data
(60) Provisional application No. 61/031,610, filed on Feb. 26, 2008.

(51) Int. Cl. H04W 8/04; H04W 36/00; H04W 4/14

(52) U.S. Cl. 455/433; 455/432.1; 455/466

(57) ABSTRACT

A method and system for virtual roaming for mobile communication devices. The mobile communication device may preferably roam between any two or more mobile communication networks, optionally in different countries.

This Application claims priority from U.S. Provisional Application No. 61/031,610, filed on Feb. 26 2008, which is hereby incorporated by reference as if fully set forth herein.

### FIELD OF THE INVENTION

The present invention is of a system and method for virtual roaming for mobile communication devices, and in particular, to such a system and method in which such roaming between mobile communication networks features the use of local mobile communication numbers.

### BACKGROUND OF THE INVENTION

Mobile communication devices are now ubiquitous within many countries; indeed penetration of such devices is rapidly increasing internationally. Such devices offer many advantages in terms of flexible communication without being tied to a particular location. Travelers can now roam between different mobile communication networks, in the same country or even in different countries, without cessation of service.

However such roaming currently has many drawbacks. For example, one who wishes to contact the mobile communication device of a user who is currently local but which originates in another country must pay for a long distance telephone call—even if the two communicating parties are standing next to each other. Furthermore, users of non-local mobile communication devices must pay a high tariff for telephone calls to be transferred from their “home” mobile communication network to the mobile network at their current location. Also the quality of voice communication may be lowered by the need for relaying the call from the user's current location back to the home mobile network, and then from the home mobile network back to the network at the user's current location. Unfortunately, currently the only solution is to use more than one SIM card (for GSM telephones) or even more than one telephone, which is clearly disadvantageous.

### SUMMARY OF THE INVENTION

There is thus an unmet need for, and it would be highly useful to have, a system and method for virtual roaming for mobile communication devices.

The present invention overcomes these drawbacks of the background art by providing a method and system for virtual roaming for mobile communication devices, which does not require the user to switch SIM cards or telephones, or otherwise to manipulate the mobile communication device, for mobile communication devices that are capable of communication on any type of GSM and/or UMTS (or combined) network.

It should be noted that reference to a mobile communication device network includes but is not limited to GSM, UMTS and a combined GSM and UMTS network structure (for example the R99 Architecture, although such a combination is not limited to such an architecture). Reference to the GSM network also includes but is not limited to GSM, GPRS and EDGE technologies. Reference to the UMTS network also includes but is not limited to HSDPA and HSUPA technologies.

By “mobile communication device” it is meant any portable device, such as a cellular telephone, PDA or other computer having voice and/or digital communication capabilities, or any digital device featuring a data processor and voice communication capabilities through any type of communication network, whether a voice communication network, a data communication network or a computer network, according to any protocol, whether a voice communication protocol, a data communication protocol or any other suitable protocol.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “mobile communication device” on a “network”, featuring a “server” and preferably for cellular communication, it should be noted that optionally any two or more mobile communication devices in communication with each other, and/or any computer in communication with a mobile communication device, may optionally comprise a “network”, which may (for example) optionally be a computer network and/or a cellular network.

A “server” as termed herein may optionally comprise any computer connected to a GSM network, whether directly or indirectly (for example through any type of computer network, including but not limited to the Internet). It should be noted that optionally any device featuring a data processor and/or the ability to execute one or more instructions may be described as a computer, including but not limited to a PC (personal computer), a server, a minicomputer. Any two or more of such devices in communication with each other, and/or any computer in communication with any other computer, may optionally comprise a “computer network”, including but not limited to the Internet.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1 and 2 are schematic block diagrams of exemplary systems according to the present invention;

FIG. 3 shows a flowchart of an exemplary, illustrative method of the present invention for authentication, which may optionally be performed with the system of FIGS. 1 or 2 for example;

FIG. 4 shows a flowchart of an exemplary, illustrative method of the present invention for implementation of a SRVNO according to some embodiments of the present invention;

FIG. 5 shows a flow process diagram of an exemplary, more detailed method for location updating upon entry of a mobile device to an area served by a local network;

FIG. 6 shows a flow process diagram of an exemplary, more detailed method for authentication of the mobile device as for the situation described in FIG. 5, according to some embodiments of the present invention;

FIG. 7 shows a flow process diagram of an exemplary, more detailed method for receiving such a telephone call according to some embodiments of the present invention;

FIG. 8 shows a flow process diagram of an exemplary, more detailed method for receiving a telephone call made to the local network MSISDN of the MS according to some embodiments of the present invention;

FIG. 9 shows an exemplary flow process for forwarding calls from the local network MSISDN to the MS when present in the home network according to some embodiments of the present invention;

FIG. 10 shows notification of the SRVNO for further call processing once the mobile device returns to the home network;

FIG. 11 describes an exemplary flow process for a situation in which the location updating is not accepted, for example if the mobile device is in contact with a forbidden local network, according to some embodiments of the present invention;

FIGS. 12 and 13 show exemplary flow processes for handling SMS messages according to some embodiments of the present invention;

FIG. 14 describes an exemplary process flow when an SMS message is sent to the local network MSISDN associated with the mobile device, but the mobile device is in contact with the home network, according to some embodiments of the present invention;

FIG. 15 describes an exemplary, illustrative process flow for sending a SMS message by the mobile device to an international MSISDN (ie, an MSISDN that is not part of the local network, but not necessarily in a different country or region) while in contact with the local network, according to some embodiments of the present invention;

FIG. 16 describes an exemplary, illustrative process flow for sending a SMS message by the mobile device to a local network MSISDN while in contact with the local network, according to some embodiments of the present invention;

FIGS. 17 and 18 relate to illustrative flows for two different exemplary types of call forwarding, according to some embodiments of the present invention;

FIG. 19 illustrates an exemplary flow for activating call forwarding from outside of the home network by the mobile device, according to some embodiments of the present invention;

FIG. 20 relates to an exemplary data structure for the user profile information, which is preferably stored at the SR-HLR, according to some embodiments of the present invention;

FIG. 21 relates to provision of USSD (Unstructured Supplementary Service Data) when the mobile device is communicating through the local network, according to some embodiments of the present invention;

FIG. 22 relates to a process according to the present invention for virtual roaming with a R-UID card, according to some embodiments of the present invention;

FIG. 23 relates to a method for SIM card manufacture according to some embodiments of the present invention; and

FIG. 24 relates to a flowchart for implementation of smart roaming through the use of the SIM card according to some non-limiting embodiments of the present invention.

### DESCRIPTION OF THE PREFERRED EMBODIMENTS

The present invention is of a method and system for virtual roaming for mobile communication devices. The mobile communication device may preferably roam between any two or more mobile communication networks, optionally in different countries. As described herein, the “home network” refers to the mobile communication network to which a particular mobile communication device is a direct subscriber. By “direct subscriber”, it is meant that the mobile communication device may be authenticated by the home network and/or that payment for use of the mobile communication device on the home network is paid directly to the host company of the home network. A “local network” refers to the mobile communication network with which the mobile communication device is currently communicating if this network is different from the home network. Optionally, the local network is located in a different country as compared to the home network, although this is not necessary.

Although the present invention is described herein with regard to a cellular telephone network, particularly such a network operating according to any of the GSM, GPRS, EDGE and UMTS, HSDPA and HSUPA standards, it is understood that this is for the purpose of description only and is not intended to be limiting in any way. For example, optionally various types of wireless networks such as for example WiMAX may be used for implementing the present invention in at least some embodiments.

According to some embodiments of the present invention, in which the mobile communication device is a cellular telephone and the mobile communication device network is a cellular telephone network operating according to GSM, GPRS, EDGE and UMTS, HSDPA and HSUPA standards.

According to some embodiments of the present invention, virtual roaming between mobile networks, described herein as “smart roaming”, is supported by a SRVNO (smart roaming virtual network operator), which enables the mobile device to be located between the plurality of available networks, including at least one local network and the home network as described herein. The SRVNO also preferably supports authentication of the mobile device to the home network when the mobile device initiates communication with the local network, also as described in greater detail below. Each local network preferably has an agreement with the SRVNO, such that each such local network may be described as a SRVNO associated local network. The agreement preferably enables billing to be made through the home network to the subscriber of the mobile device, while also more preferably providing wholesale prices for use of the local network to the SRVNO.

The SRVNO more preferably does not have any physical infrastructure of its own, optionally apart from a SR-HLR, and preferably also apart from a SR-VLR and other “core network” components. Instead the SRVNO preferably is associated with an actual network operator, which owns and operates the physical infrastructure of a mobile device network, such as base stations and other required components. Communication between the SRVNO and the local network and home network preferably occurs through SS7 or any other suitable network, as described in greater detail below. However, the SR-HLR and other core components of the SRVNO are preferably separate from those of the home network, the local network and also the actual network operator.

According to some embodiments of the present invention, smart roaming (virtual roaming between mobile networks) is enabled through the addition of functionality to the SIM card for GSM compatible devices, as a non-limiting example only of a mobile device and network. Preferably the SIM card features a plurality of IMSIs, with at least one IMSI associated with the home network of the mobile device and at least one IMSI associated with at least one other network, described herein as the “local network” for the purpose of illustration only and without any intention of being limiting. Each such latter IMSI is described herein as a SR-IMSI. In addition, preferably the SIM card features a single Ki, associated with the home network, such that authentication preferably occurs through the home network. The home network is therefore liable for billing and payment, for example.

The SIM card functionality is preferably supported by a software application, which preferably includes dual IMSI management, which is an application that on SIM boot sequence selects the IMSI to use for the boot process; i.e. the home IMSI on the home network, or one of the SR-IMSIs while in communicating through a local network. As described in greater detail below, the SIM card also preferably includes a software application for SRVNO home network management, which forces the SIM to behave with regard to all local networks associated with the SRVNO as for the home network. Another application, the SR Visitor MSISDN set on handset screen, preferably is provided to display the temporary/permanently assigned visitor local number (VLN) MSISDN on the mobile device handset screen following the MS registration in a SRVNO associated local network.

Another preferred software application supports SR out call management, which routes out-going international calls to a call back scenario or a call through scenario (i.e. via a local gateway) whenever the subscriber attempts to make such an international mobile call originating while the mobile device is communicating through a SRVNO associated local network. Yet another preferred software application supports SR-IMSI update, which enables OTA (over the air) update of the software and/or other information on the SIM card, more preferably including the addition of another SR-IMSI to the SIM card.

A SR local network update software application preferably enables OTA updating of a SRVNO local network change i.e. modifying the SIM card behavior to treat a certain network as a SRVNO associated local network.

SR call duration monitoring is an application that preferably logs call duration while on a SRVNO associated local network and that notifies the SR-USSD—this application can be activated or deactivated upon an OTA request.

The SIM card also preferably features a software application for MCC (mobile country code) and Country Prefix (CP) management to determine when telephonic communication is in fact a local call (ie to a local telephone number). Once location updating is performed as described in greater detail below, the application preferably retrieves the MCC and compares it to the MCC/CP mapping table in the SIM card, in order to store the CP of the visited country. For example, once the mobile device has been authenticated in Hong Kong, the SIM card receives information indicating that the MCC=454. The mapping table on the SIM card preferably then is used to determine that the CP=852, which means that all dialed number beginning with +852 are in fact local calls (or at least not international calls; the concept may also easily be extended to regional calls for example). The mapping table is preferably stored in a file updatable through OTA (over the air) updating.

The SIM card software application also preferably informs the SRVNO of the location of the mobile device, with regard to the mobile network with which the device is communicating at any given time. For example, when the SIM card is powered on in mode of home network, such that the mobile device is communicating through the home network, the software application on the SIM card preferably sends a USSD message to the SR-HLR/USSD regarding this event, to enable the SR-HLR to deregister the SR-IMSI and forward all future events to the home IMSI until further notice. This software application therefore enables the subscriber (user) to move the mobile device seamlessly between networks, without requiring the user of the mobile device to change SIM cards or to otherwise perform any type of manual activity; detection of the location of the mobile device with regard to a particular network is preferably performed automatically and this information is also preferably communicated automatically to the SRVNO.

According to some embodiments of the present invention, there is provided the use of a single Ki with multiple IMSIs on a SIM card, even without use of the SRVNO as described herein. Alternatively or additionally, there is provided the use of multiple IMSIs on a SIM card with software for selection of the correct IMSI, without input or action by the user of the mobile device.

According to other embodiments of the present invention, there is provided a method for connecting a plurality of roaming mobile networks to a single virtual mobile network, in which the single virtual mobile network features a controlling core network component, such as the SR-HLR described herein but without limitation thereto, but otherwise preferably does not feature any infrastructure components for actually transmitting telephone calls or data. Instead, preferably the virtual mobile network handles identification of the mobile device and optionally also authentication (whether directly or in conjunction with the home mobile network of the mobile device), after which at least telephonic communication is more preferably performed directly between the networks, without reference to the controlling virtual mobile network. The plurality of mobile networks preferably contract with the single virtual mobile network, which in turn contracts with the home mobile network in order for subscribers to the home mobile network to gain access to the roaming mobile networks associated with the single controlling virtual mobile network.

Optionally, even if a roaming mobile network is included within the scope of the single virtual mobile network operator, it is possible for that network to be excluded from use by a particular mobile device, for example for contractual reasons with the home mobile network.

The principles and operation of the present invention may be better understood with reference to the drawings and the accompanying description.

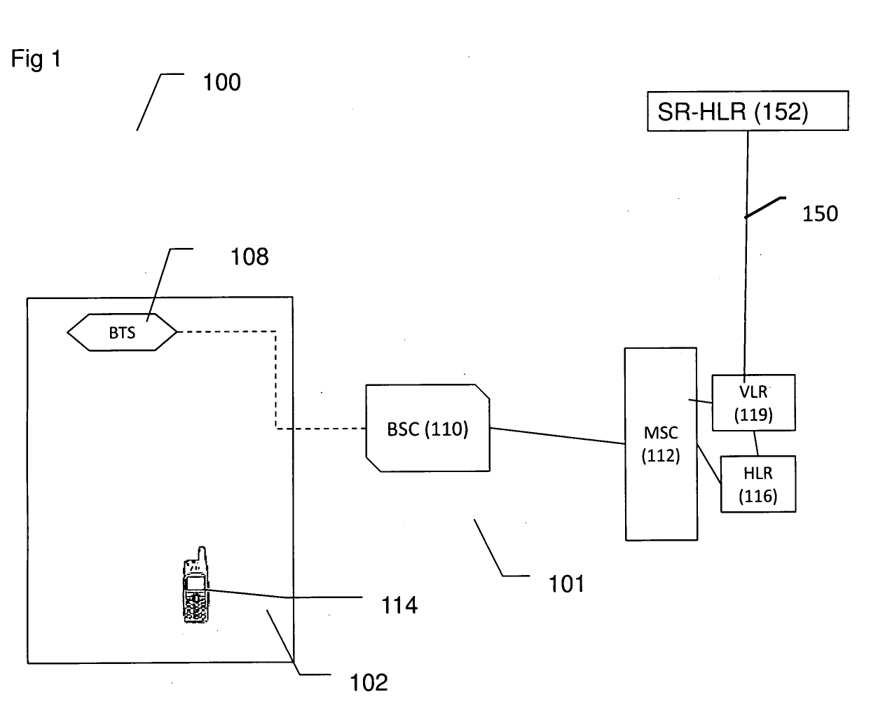

FIG. 1 shows a schematic block diagram of an exemplary system according to the present invention. It should be noted that all connections shown are logical connections, as are all components, and may not in fact exist as physical connections and/or components. Also the following example relates to an illustrative, non-limiting implementation only, as many different implementations are possible and are contemplated within the present invention, which is operable with any public land mobile network (PLMN). For this example and without any wish to be limiting, these components are assumed to operate according to the GSM protocol. However, at least some components of a typical GSM network are not shown for clarity only and without any intention of being limiting in any way.

As shown, a system 100 preferably features a local cellular network 101 comprising at least one cell 102 and preferably a plurality of cells 102 (not shown).

Each cell 102 comprises a BTS (Base Transceiver Station) 108, which in turn communicates with a BSC (Base Station Controller) 110. BSC 110 in turn communicates with a network core 106, including a MSC (Mobile Switching Center) 112. BTS 108 is the physical equipment that provides radio (cellular transmission) coverage to the geographical part of the cell 102 for which it is responsible. It should be understood that the BSC 110 may be connected to several BTSs 108, and may be implemented as a stand-alone node or integrated with the MSC 112.

A MS (mobile station) 114 is in contact with cellular network 101. Each MS 114 is the physical equipment, e.g., a cellular telephone, car phone or other portable phone or any other GSM, UMTS or other cellular communication modules, or any type of mobile communication device, used by mobile subscribers to communicate with the cellular network 110, each other, and users outside the subscribed network, both wireline and wireless. MS 114 also includes a Subscriber Identity Module (SIM) card (not shown), and/or optionally other memory, which provides storage of subscriber related information, such as a subscriber authentication key, temporary network data, and service related data, such as language preference.

When a MS (mobile station) 114 first enters cell 102, from an external location (not shown), MS 114 preferably passively reads (through one way communication) the cell parameters from BTS 108. BTS 108 transmits the cell parameters, including a LAC (location area code) for cell 102 which is unique to cell or array of relevant cells 102. Since the LAC is unique to cell or array of cells 102, MS 114 recognizes that MS 114 has entered a new LA (location area) and indicates this information to BTS 108. Optionally, to assist the process of the present invention for location updating according to some embodiments as described in greater detail below, the user may optionally be asked to switch off and on MS 114, for example through a message displayed on the screen of MS 114.

BTS 108 in turn provides the information that MS 114 has entered the LAC specified for cell 102 to BSC 110. BSC 110 in turn provides the information that MS 114 has entered the LAC specified for cell 102 to MSC 112. The information provided preferably includes the IMSI (International Mobile Subscriber Identity) and the IMEI (International Mobile Equipment Identity) for MS 114. The IMEI is unique to the physical device itself for MS 114, while the IMSI is associated with the SIM (Subscriber Identity Module) card in MS 114 and hence typically with the subscriber. The IMSI may optionally be transmitted as a TMSI (Temporary Mobile Subscriber Identity), a randomly generated number which is generated by the network. However, for ease of description, reference is only made to the IMSI.

It should be noted that the above process occurs even if MS 114 is in passive mode (ie not performing voice or data communication).

MSC 112 now needs to update a VLR (Visitors Location Register) 119, to inform VLR 119 of the change to the LA. VLR 119 is a database containing information about all of the MSs 114 currently located within the area controlled by VLR 119. VLR 119 may be co-located with a given MSC 112, for example may optionally be integrated with the MSC 112.

VLR 119 in turn updates a HLR (Home Location Register) 116 and an OSS (not shown), if MS 114 were to be subscribed to local network 101. HLR 116 is a database maintaining all subscriber information, e.g., user profiles, current location information, International Mobile Subscriber Identity (IMSI) numbers, and other administrative information.

In this example, MS 114 is assumed to not be a subscriber to local network 101. Therefore, instead of reporting to HLR 116, VLR 119 reads the information from MS 114 and then sends a request for authentication to SR-HLR 152 through the SS7 network 150, for example. SR-HLR 152 is a HLR which is not related to local network 101 and which is preferably located remotely to local network 101. As used herein, the prefix “SR” (“smart roaming”) refers to a component according to the present invention.

SS7 network 150 is any network capable of communication according to the SS7 (Signaling System Number 7) protocol, which for the purpose of the present description is specifically used for Non-Call-Associated Signaling, in order to support communication generally to any HLR as is known in the art.

According to preferred embodiments of the present invention and as described in the examples herein, SR-HLR 152 is preferably not part of the network to which MS 114 is a subscriber (referred to herein as the “home network”; not shown), but rather is a separate HLR, separate from both the home network and local network 101.

SR-HLR 152 preferably features at least a list of identifiers for MS 114, which enable SR-HLR 152 to identify the home network of MS 114. Such a list of identifiers may optionally be statically stored and/or may be generated from information sent by VLR 119. Preferably a combination of such information is used, with both one or more transmitted components by VLR 119 and also one or more statically stored components at SR-HLR 152. As described in greater detail below, SR-HLR 152 may optionally use such information to authenticate MS 114 directly; however, alternatively and preferably SR-HLR 152 authenticates MS 114 through the home network (not shown; see below). In any case, preferably the home network HLR (not shown) is updated as to the location of MS 114, which in this example is communicating with local network 101.

According to at least some embodiments of the present invention, MS 114 features a SIM card (not shown) with a plurality of IMSI numbers. MS 114 is also associated with a plurality of MSISDN (Mobile Subscriber Integrated Services Digital Network Number) numbers. MSISDN identifies MS 114 to the network with which MS 114 is communicating; it typically features a country code, a network identification code (for identifying the home network of MS 114) and a subscriber number, for identifying the subscriber associated with MS 114 and is also described herein as a telephone number for ease of use. In at least some embodiments of the present invention, the SIM card preferably has at least one IMSI for the home network of MS 114 and at least one IMSI associated with SR-HLR 152. However, as described in greater detail below, the SIM card may optionally and preferably only feature a single authentication identifier (Ki).

Authentication of MS 114 optionally and preferably involves the identification of the IMSI associated with SR-HLR 152; sending this information to SR-HLR 152; and authentication of MS 114 as previously described, for example by sending at least the IMSI associated with the home network of MS 114 to the home network (see also below for more details).

Once MS 114 has been authenticated, SR-HLR 152 informs VLR 119 that MS 114 has been authenticated. Preferably, MS 114 is now assigned a local network MSISDN that is local to local network 101. By “local network MSISDN” it is meant that the assigned MSISDN is a number serviced directly by MSC(s) of local network 101. The local network MSISDN may optionally be assigned in a number of different ways. For example and without limitation, the local network MSISDN may optionally be selected from a plurality of such numbers stored at SR-HLR 152 and assigned on a “first come, first serve” basis as available. Alternatively, the local network MSISDN may optionally be selected from a plurality of such numbers stored at local network 101, and again assigned on a “first come, first serve” basis as available. Also alternatively, the local network MSISDN may optionally be stored at SR-HLR 152 as being assigned to MS 114, whether permanently or for an extended period of time. By “extended period of time” it is meant that the local network MSISDN remains associated with MS 114 even after MS 114 ceases to communicate with local network 101 (for example because the user of MS 114 has traveled out of the geographical area served by local area network 101). The local network MSISDN may also optionally be pre-assigned to MS 114 even before MS 114 starts to communicate with local network 101 (for example if a traveling user wishes to receive a telephone number in advance). These possibilities are not necessarily exclusive.

If another MS (not shown) within local network 101 wishes to call MS 114, the user of the other MS would enter the local network MSISDN of MS 114 to that user's MS. Communication would proceed to MSC 112 of local network 101, which would then consult SR-HLR 152 to locate MS 114. The call would then proceed as for any telephone call to a subscribing MS of local network 101, as preferably it would not be necessary to connect through SR-HLR 152 once roaming was established, as described in greater detail below.

On the other hand, if yet another telephonic device (not shown), outside of local network 101, calls the home network MSISDN of MS 114 (that is, the telephone number of MS 114 in the home network), then as described in greater detail below, the HLR of the home network preferably communicates directly with VLR 119 of local network 101 to set up a direct telephonic connection. According to preferred embodiments of the present invention, it is not necessary for communication to proceed through SR-HLR 152 once roaming has been initiated and MS 114 has been authenticated.

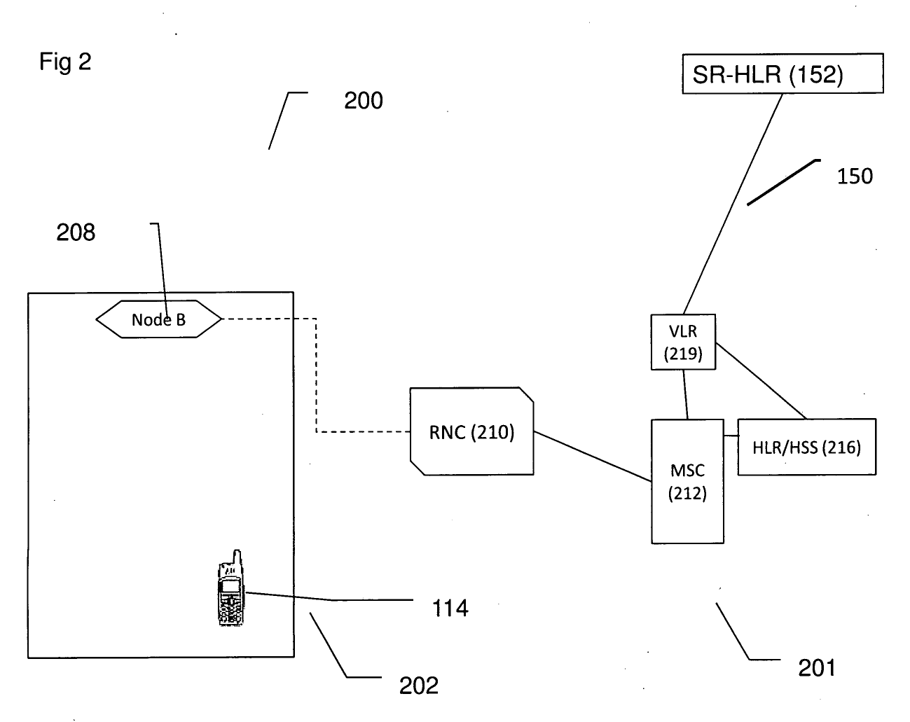

FIG. 2 shows an exemplary implementation of the system of FIG. 1, with a cellular network implemented according to UMTS as another non-limiting example. Elements with the same reference number as for FIG. 1 have the same or at least a similar function as for FIG. 1.

A system 200 again features a cellular network 201 with a plurality of cells 202. The BTS is now replaced by a node 208; the BSC is now replaced by a RNC (radio network controller) 210; VLR 219 and MSC 212 have similar if not identical functions as in FIG. 1. The HLR is replaced by a HLR/HSS 216. All of these components function at least similarly to the description provided in FIG. 1, again supporting roaming as described above with regard to FIG. 1.

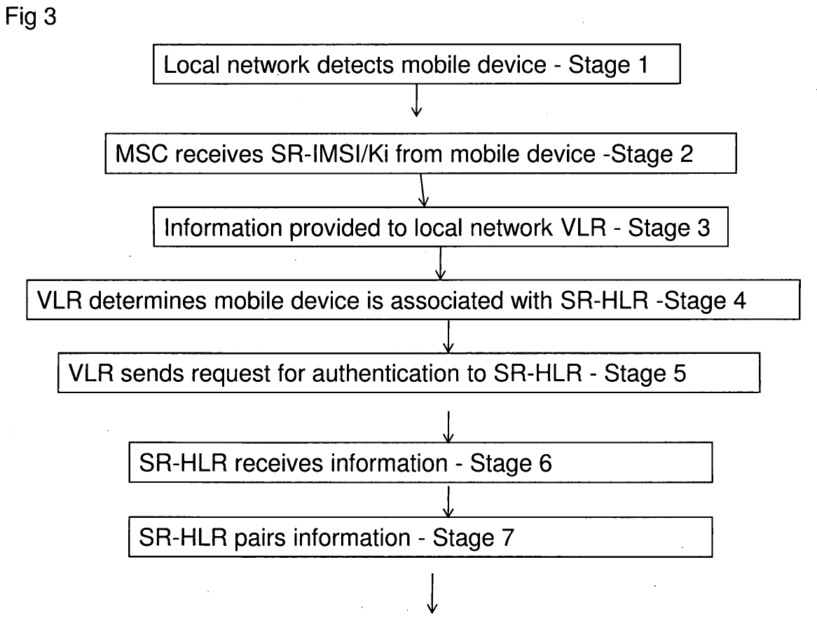

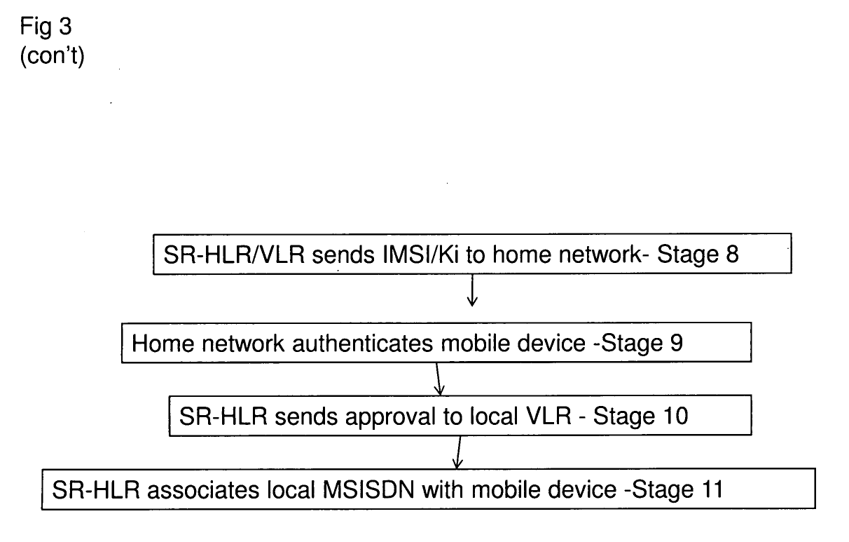

FIG. 3 relates to an exemplary, illustrative flow chart for identifying the mobile device, such as MS 114 of FIG. 1, for authentication purposes. In stage one, a local network that is different from the home network of the mobile device detects the presence of the mobile device. In stage two, the MSC receives at least the SR-IMSI and preferably also the Ki from the mobile device. Preferably, the SR-IMSI is selected and sent from the mobile device according to a software application or other code, which indicates that the SR-IMSI should be sent but not the home network IMSI. The software application preferably selects the SR-IMSI according to information received by the mobile device regarding the identity of the network with which the mobile device is in communication (in this example, a local network which is different from the home network). Since the mobile device is in communication with a network that is not the home network, but which is in communication with SR-HLR, the software application preferably selects the SR-IMSI. More preferably, the Ki is shared between the local network and the home network as described in greater detail below, such that the Ki is sent by the software application upon detection of communication with the local network. Optionally and most preferably, the SIM card features only one Ki, as described in greater detail below. Also all authentication procedures are optionally and most preferably performed with the home network using the single Ki on the SIM card.

The software application preferably includes a list of networks for which the SIM card is to operate as described herein for the SRVNO, and more preferably as for the home network itself. For example, the software application preferably includes the SIM card to preferentially interact with one of the listed networks, as opposed to interacting with a network selected according to other considerations, such as signal strength for example. More preferably, each network is related to a particular country or region. As described in greater detail below, preferably each such network is associated with a separate IMSI, which is stored on the SIM card and which is selectable by the software application. Most preferably, changes to the software application may be made over the air, for example to add a new IMSI (related to a new network) and/or to change the identity of one of the listed networks.

In stage three, the SR-IMSI is provided to the VLR of the local network. In stage four, the VLR analyzes the SR-IMSI and determines that the mobile device is associated with a SR-HLR as described for FIG. 1. The VLR of the local network then sends a request for authentication to the SR-HLR in stage five.

In stage six, according to some optional embodiments of the present invention, the SR-HLR preferably receives at least the SR-IMSI and more preferably receives the Ki as well. The SR-HLR then preferably pairs this information to information stored in a database at the HLR, in order to determine the home network of the mobile device, in stage seven. In stage eight, SR-HLR/VLR (as preferably the VLR of the SR performs this function) sends at least the home IMSI associated with the home network to the HLR of the home network for authentication. Optionally and more preferably, the SR-HLR is able to determine the Ki (subscriber authentication key) of the mobile device as described previously, and sends this information as well to the HLR of the home network. Most preferably and as previously described, the SIM card has only one Ki, which is associated with the home network, since once the mobile device has been authenticated, the Ki is no longer required and so a separate Ki for the SR-HLR is not needed.

In stage nine, the HLR of the home network authenticates the mobile device and sends approval to the SR-HLR. In stage ten, the SR-HLR transmits this approval to the VLR of the local network. In stage eleven, the mobile device becomes associated with a local network MSISDN of the local network, preferably through the SR-HLR as described in greater detail below.

According to at least some embodiments, the SR-HLR is considered to be part of a SRVNO (smart roaming virtual network operator), which is associated with an actual mobile network operator but which does not itself own or operate any of the mobile network hardware, apart from the SR-HLR. The SR-HLR is preferably in communication with the actual mobile network operator, for example to permit communication through the SS7 network; the SR-HLR may optionally even be present on the physical premises of the actual mobile network operator.

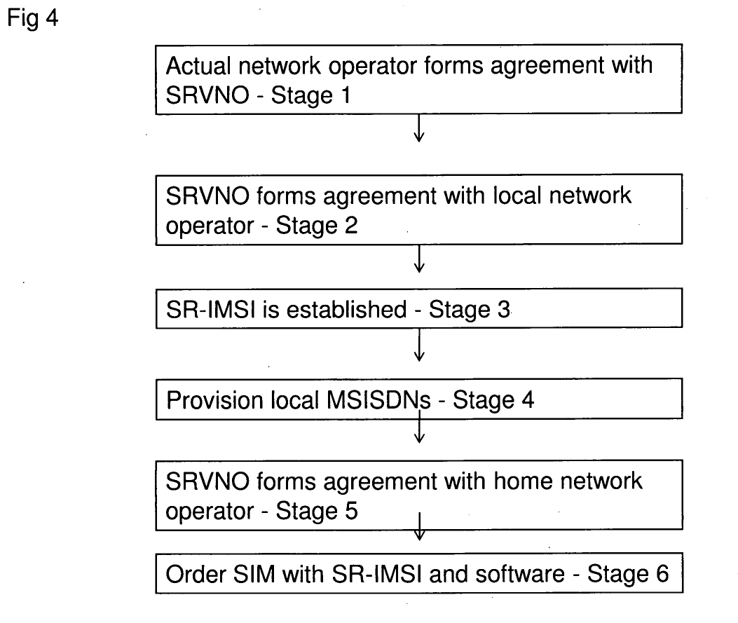

FIG. 4 relates to this optional embodiment and describes an optional method for the process flow between the home network operator, the local network operator and the above SRVNO (and its actual network operator). In stage one, the actual network operator forms some type of agreement with the SRVNO. In stage two, the SRVNO forms an agreement with at least one local network operator (other than the actual network operator), in which the local network operator agrees to provide a plurality of local network MSISDNs (whether on a permanent or non-permanent basis, or a combination thereof) and to recognize the identifier of the SRVNO (for example with regard to the SR-IMSI as described above) from a mobile device, for example for the embodiment relating to the SIM card as described above. This agreement may optionally be an MVNO agreement as described in greater detail below.

In stage three, the SR-IMSI is established, which enables the local network to locate the SRVNO and its components, such as for example the SR-HLR as described herein. In stage four, preferably a plurality of local MSISDNs are provided to the SRVNO from the local network operator.

In stage five, the SRVNO forms an agreement with at least one home network operator (which is other than the local network operator or the actual network operator), to permit subscribers to the home network operator to be authenticated according to the above process and to receive a local network MSISDN from the local network operator, also as described above. Optionally, in stage six, the home network operator may add the desired SR-IMSI numbers to the SIM card of subscribers to the home network operator upon manufacture, as described in greater detail below.

It should be noted that the local network operator and/or the home network operator may itself be a mobile virtual network operator (MVNO). Indeed the SRVNO may optionally be considered to be a MVNO that is international in scope, present in a plurality of countries. Furthermore, optionally the SRVNO may be implemented as a multi-network MVNO; currently in the art, each MVNO is only available on a single network.

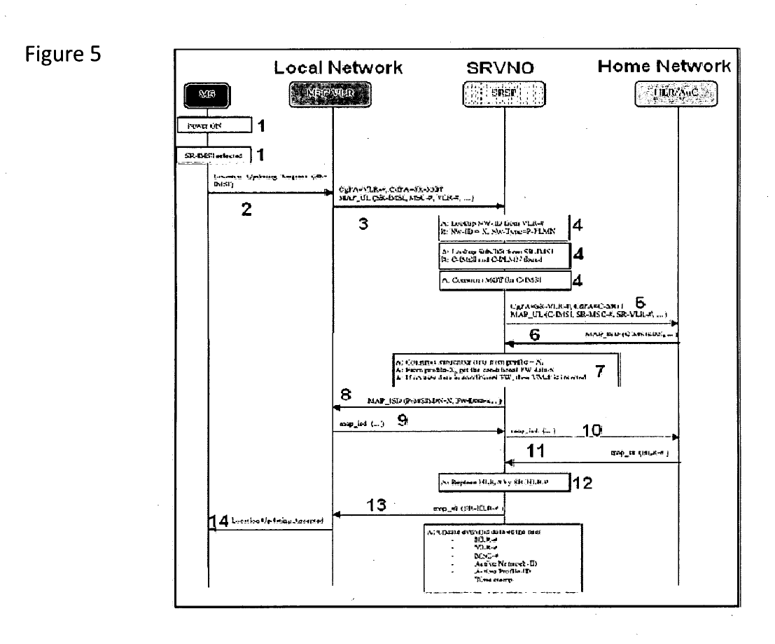

FIG. 5 shows a flow process diagram of an exemplary, more detailed method for location updating upon entry of a mobile device to an area served by a local network. Communication occurs between the mobile device (MS), local network, home network and SRVNO according to the present invention.

In stage 1, the MS is in the power-on state with communication with the local network and the appropriate SR-IMSI for the SRVNO, as described above, is selected according to the software application resident on the SIM card. In stage 2, a location updating request is sent with the SR-IMSI to the MSC/VLR of the local network. The local network recognizes that the network operator corresponding to the SR-IMSI is the SRVNO and so transfers this information to the SRVNO in stage 3 (the term “SRSP” refers to the smart roaming service platform, which is associated with the SRVNO and performs the functions described herein).

In stage 4, the SRVNO uses the SR-IMSI to find the IMSI of the home network and also the identity of the home network for the MS. Preferably, the authentication key (Ki) of the MS is sent from the SIM card with the SR-IMSI as described herein. In stage 5, this information is sent to the HLR/AuC (authentication center). In stage 6, if authenticated successfully, an acknowledgement is sent to the SRVNO. In stage 7, the SRVNO constructs subscriber data from any stored profile for the MS, such as a pre-ordered or already existing local network MSISDN for example. If no such number exists, then the MS is assigned a local network MSISDN as described above. In stage 8, the local network MSISDN assigned to the MS is sent to the local network. In stage 9, an acknowledgement is sent from the local network to the SRVNO. In stage 10, an acknowledgement is sent from the SRVNO to the home network.

In stage 11, the home network sends the HLR number of the home network to the SRVNO, which replaces it with the SR-HLR number (ie the address of the HLR at the SRVNO) in stage 12. In stage 13, the SR-HLR number is sent to the local network, which then acknowledges to the MS that the location updating was accepted.

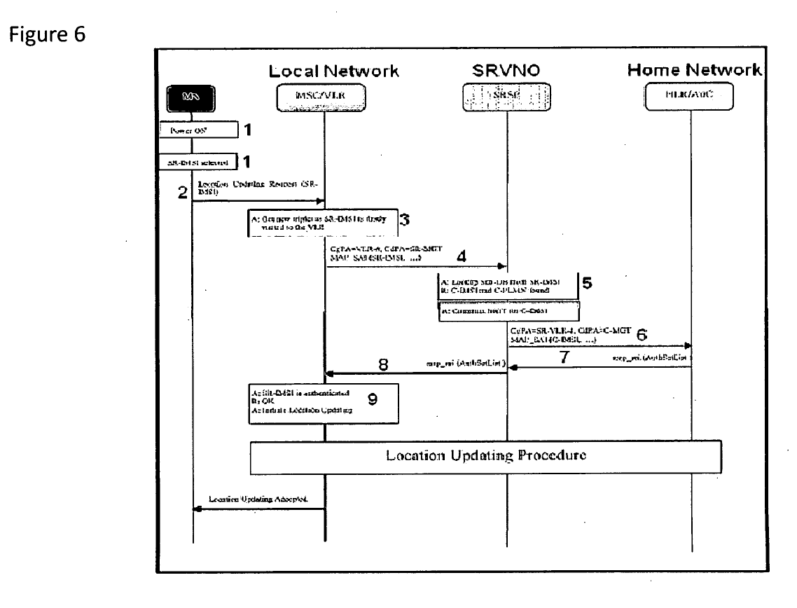

FIG. 6 shows a flow process diagram of an exemplary, more detailed method for authentication of the mobile device as for the situation described in FIG. 5, according to some embodiments of the present invention. Stage 1 is performed as for FIG. 5. In stage 2, a location updating request is sent to the local network.

In stage 3, the local network prepares the VLR number for the SRVNO, the SR-MGT (SR mobile gateway) and the SR-IMSI. In stage 4, this information is transmitted to the SRNVO. In stage 5, the SRVNO locates the home IMSI for the MS at the home network and any other appropriate information, and sends this information to the home network in stage 6. As noted previously, the SRVNO preferably receives the Ki from the SIM card. In stage 7, the home network sends acknowledgement of authentication to the SRVNO, which passes it on to the local network in stage 8. In stage 9, the local network initiates location updating, after which the process of FIG. 5 is optionally and preferably performed.

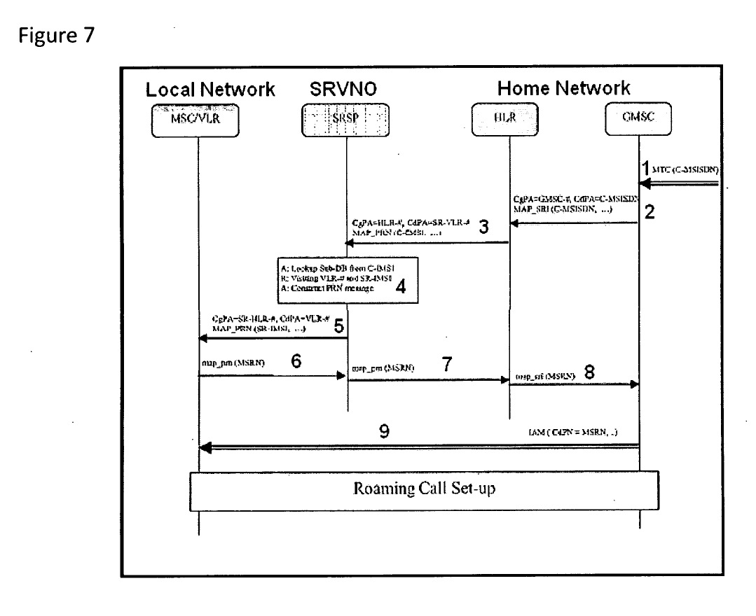

As previously described, the MS can receive telephone calls to the MSISDN of the home network while communicating through the local network. FIG. 7 shows a flow process diagram of an exemplary, more detailed method for receiving such a telephone call according to some embodiments of the present invention. In stage 1, a telephone call is made to the home network MSISDN of the MS (not shown) and is received by the GMSC (gateway MSC) of the home network. In stage 2, the MSISDN of the subscriber and the number of the GMSC are passed on to the HLR of the home network. However, as described above, the HLR is aware that the MS is now communicating through the local network. Therefore, in stage 3, the IMSI of the MS at the home network, as well as information regarding the HLR of the home network, is sent to the SRVNO. In stage 4, the SRVNO performs the previously described look-up to determine the local network MSISDN currently associated with the MS. In stage 5, this information, along with the SR-IMSI, is passed to the MSC/VLR of the local network. In stages 6-8, acknowledgements are sent back to the GMSC of the home network. In stage 9, the roaming telephone call is preferably conducted directly between the GMSC of the home network and the MSC of the local network, more preferably without passing through the SRVNO.

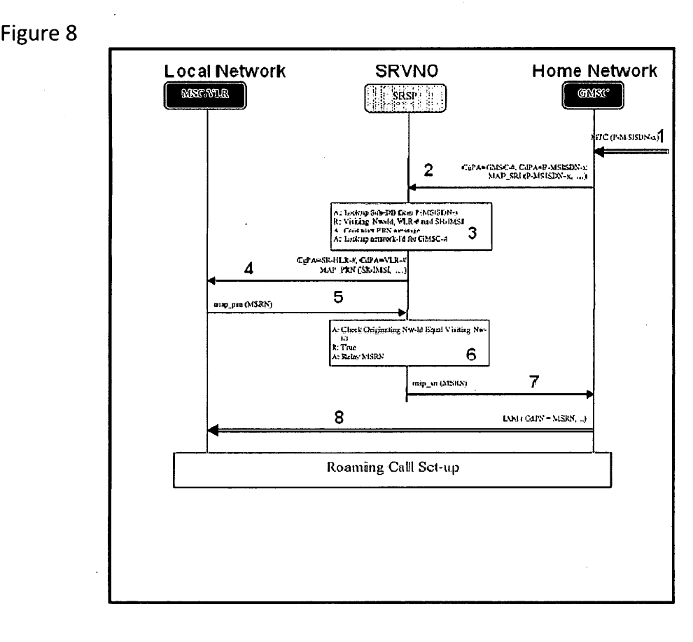

FIG. 8 shows a flow process diagram of an exemplary, more detailed method for receiving a telephone call made to the local network MSISDN of the MS according to some embodiments of the present invention. In stage 1, an incoming telephone call for the local network MSISDN of the MS is received at the GMSC (Gateway Mobile Switching Center) of the home network. In stage 2, the GMSC of the home network optionally and preferably sends a request to the SRVNO. In stage 3, the SRVNO optionally looks up the SR-IMSI of the device associated with the local network MSISDN and sends this information to the VLR of the local network in stage 4. In stage 5, the VLR returns the MSRN (Mobile Station Roaming Number), which is a number used to route telephone calls in a mobile network from the GMSC to the target MSC. In stage 6, the MSRN is reviewed to see whether the identifier of the mobile device matches that of the database at the SRVNO. In stage 7, the MSRN is returned to the GMSC. In stage 8, the telephone connection is made directly from the GMSC to the MSC, by using the MSRN.

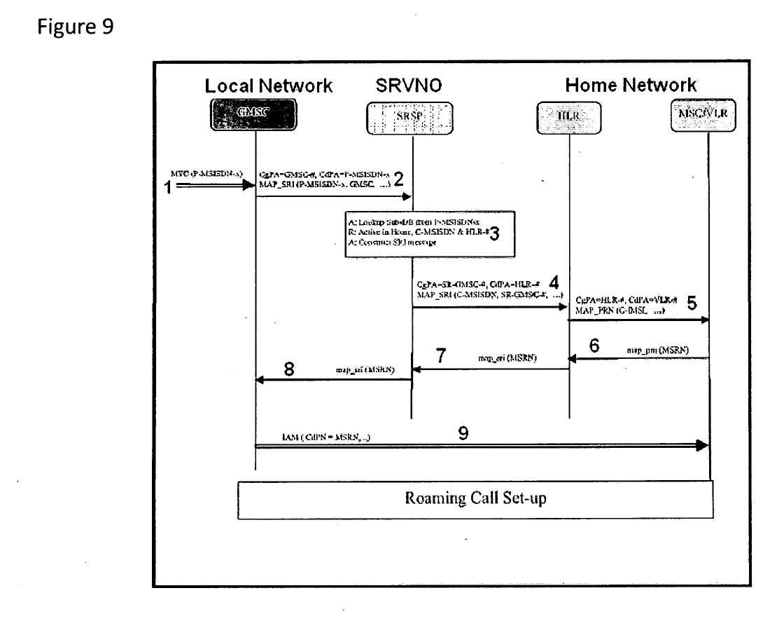

In some cases, the MS may optionally be associated for an extended period of time with a local network MSISDN at a local network, even when the MS is not communicating through the local network. FIG. 9 addresses this situation with an exemplary flow process for forwarding calls from the local network MSISDN to the MS when present in the home network according to some embodiments of the present invention. In stage 1, an incoming call is made to the local network MSISDN. In stage 2, the local network GMSC recognizes that the telephone number is assigned to the SRVNO and so passes this request to the SRNVO. In stage 3, the SRVNO checks on the status of the MS and determines that the MS is now communicating through the home network. In stage 4, the SRVNO sends the telephone number of the home network and the GMSC of the local network to the HLR of the home network. In stage 5, the HLR sends the IMSI of the MS in the home network to the MSC/VLR of the home network; the VLR then returns the MSRN in stage 6. In stage 7 the HLR returns the MSRN to the SRVNO, which then sends it to the GMSC of the local network in stage 8. In stage 9, communication then occurs between the GMSC of the local network and the MSC of the home network for the telephone call.

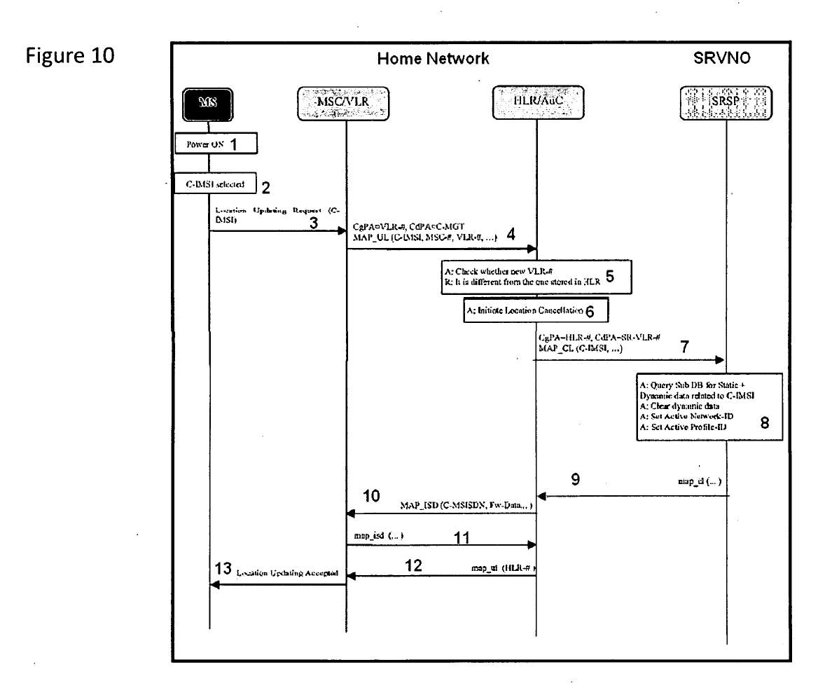

Once the mobile device returns to the home network, it is important for the SRVNO to be notified for further call processing, as described with regard to FIG. 10. As shown, in stage 1, the mobile device (MS) is powered up. In stage 2, the home network IMSI is selected by the software application on the SIM card, as the MS has received information (as previously described) that it is in contact with the home network. The home network IMSI is sent to the MSC/VLR of the home network in stage 3. The VLR number, MSC number and the home network IMSI are sent to the HLR/AuC of the home network in stage 4. In stage 5, the HLR checks to determine whether the VLR number is different, which it is, as the MS was previously not in contact with the home network but now is in contact with the home network. The HLR therefore initiates cancellation of the previous location, by sending this information to the SRVNO in stage 6. In stage 7, the SRVNO updates its database accordingly and in stage 8, acknowledges this updating to the home network. Stages 9-12 involve acknowledgement of the updated information within the home network; in stage 13, the mobile device is informed that the location updating is accepted.

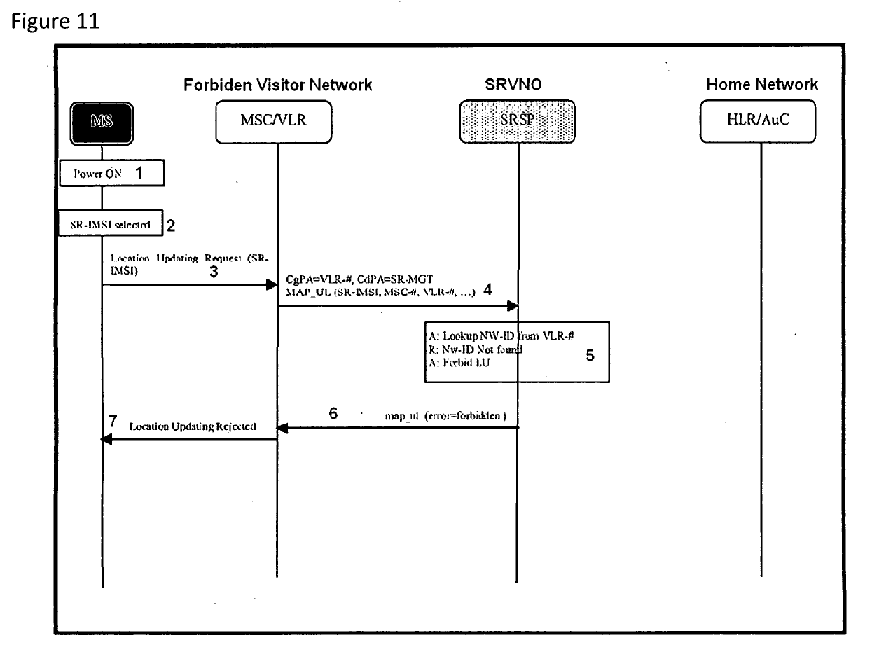

In some cases, the location updating may not be accepted, for example if the mobile device is in contact with a forbidden local network. FIG. 11 describes an exemplary flow process for such a situation. Stages 1-3 are performed as for stages 1 and 2 of FIG. 5. In stage 4, the SRVNO determines that the local network is not permitted to the mobile device, again through a look-up of data in the database. In stage 5, the SRVNO returns an error message to the local network, shown as a “forbidden visitor network” to clarify that it is not connected with the SRVNO and hence is not permitted. In stage 6, the local network indicates to the mobile device that the location updating has been rejected. As shown, preferably the home network is not involved.

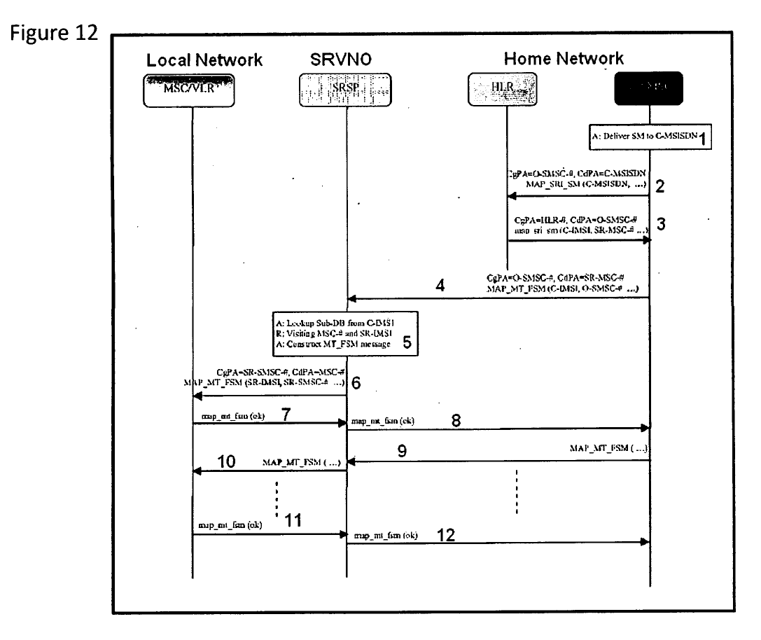

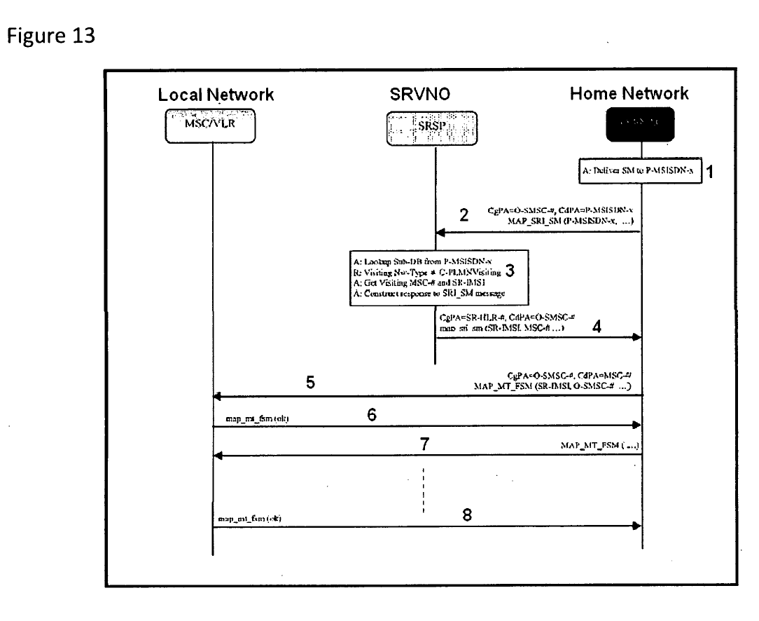

SMS (short message service) messages may also be sent to and from mobile devices when they are outside of their home network. FIGS. 12 and 13 show exemplary flow processes for handling such SMS messages. In FIG. 12, the SMS message is sent to the home network MSISDN when the MS is communicating through the local network, while in FIG. 13, the SMS message is sent to the local network MSISDN when the MS is communicating through the local network. The components are as for the above FIGS. 5-11, with the addition of an SMSC (short message service center), which is the gateway for transmitting such messages. Turning now to FIG. 12, in stage 1 an SMS message is sent to the home network MSISDN of the mobile device (not shown) and is received by the SMSC. In stage 2, the home MSISDN and the identifier of the SMSC are sent to the HLR of the home network. The HLR is aware that the mobile device is communicating through the local network and returns this information to the SMSC in stage 3.

The SMSC then sends the SMSC identifier and the home network IMSI of the mobile device to the SRVNO in stage 4. The SRVNO then preferably performs a look-up and determines the SR-IMSI and the current MSC for the mobile device in stage 5. The SRVNO then sends the SMSC identifier of the home network and the SR-IMSI to the local network in stage 6. In stage 7, the local network sends an acknowledgement to the SRVNO which passes it to the SMSC of the home network in stage 8. The SMSC of the home network then sends the SMS message to the SRVNO in stage 9, which passes it to the local network in stage 10. In stages 11 and 12, acknowledgements are sent from the local network to the SRVNO and then to the SMSC of the home network.

In FIG. 13, the SMS message is sent to the local network MSISDN of the mobile device at a time when the mobile device is communicating through the local network. In stage 1, the SMS message is sent to the local network MSISDN and is received by the SMSC of the local network. In stage 2, the SMSC identifier for the local network and the local network MSISDN of the mobile device are sent to the SRVNO. The SRVNO determines the status of the mobile device as communicating through the local network in stage 3, and then informs the SMSC at the local network of the SR-IMSI, the MSC identifier and the SR-HLR identifier in stage 4. In stage 5, the SMSC of the local network sends the SR-IMSI and its own identifier to the MSC of the local network to which the mobile device is communicating. In stage 6, the MSC acknowledges to the local SMSC, which then sends the message to the MSC in stage 7. In stage 8, the MSC acknowledges receipt to the SMSC.

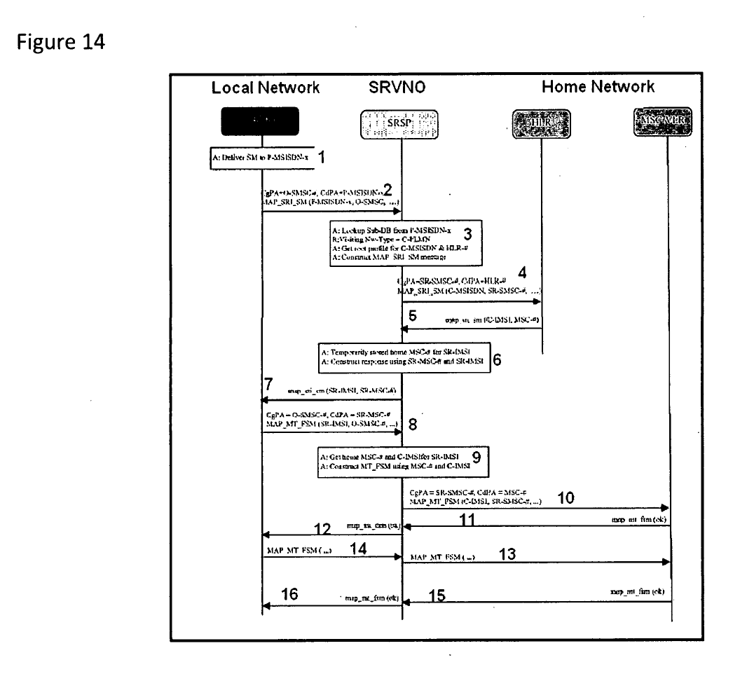

FIG. 14 describes an exemplary process flow when an SMS message is sent to the local network MSISDN associated with the mobile device, but the mobile device is in contact with the home network. In stage 1, the SMSC of the local network receives an SMS message to be sent to the local network MSISDN. In stage 2, the SMSC sends information related to this request to the SRVNO, including the SMSC number and the local network MSISDN. In stage 3, the SRVNO performs a database look-up and determines that the mobile device associated with the local network MSISDN is currently in contact with the home network. It then determines the home network MSISDN of the mobile device and the HLR number for the home network HLR. In stage 4, the SRVNO sends the SR-SMSC number (the SMSC associated with the SRNVO) and the home network MSISDN to the HLR of the home network. In stage 5, the home network HLR returns the home network MSC number and the home network IMSI of the mobile device.

In stage 6, the SRVNO stores, at least temporarily, the home network MSC number as being associated with the SR-IMSI. It then sends a response with the SR-IMSI and the SR-MSC number to the SMSC of the local network in stage 7. The local network SMSC, in stage 8, responds with a mapping of the local SMSC number, the SR-MSC number and the SR-IMSI. In stage 9, the SRVNO obtains the home MSC number and the home network IMSI corresponding to the SR-IMSI. In stage 10, the SRVNO sends the SR-SMSC number and the home network IMSI to the MSC/VLR of the home network, which then acknowledges in stage 11. The SRVNO then acknowledges to the SMSC of the local network in stage 12, after which the SMS message is transferred to the MSC/VLR of the home network through the SRNVO as intermediary in stages 13 and 14. Acknowledgement of successful receipt is made from the home network MSC/VLR to the local network SMSC, again through the SRVNO as intermediary, in stages 15 and 16.

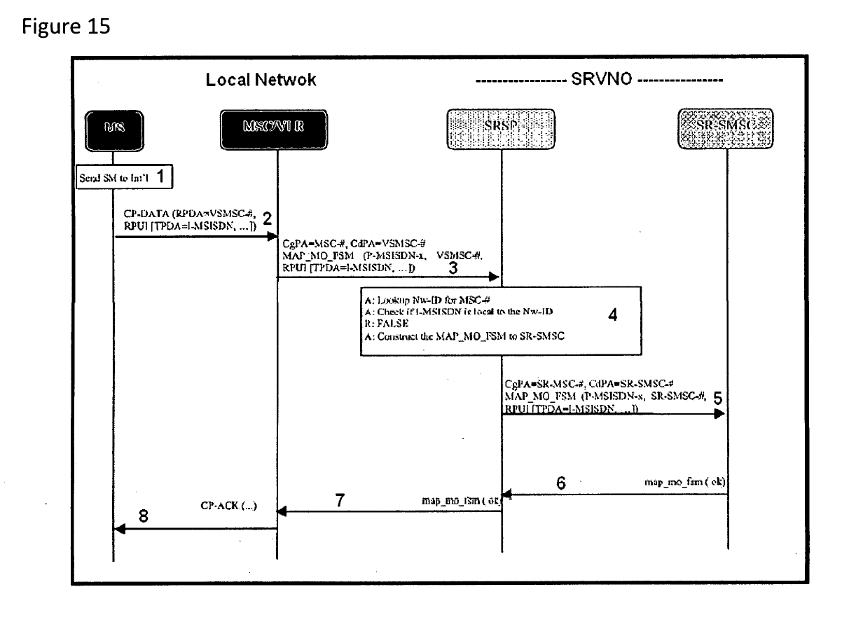

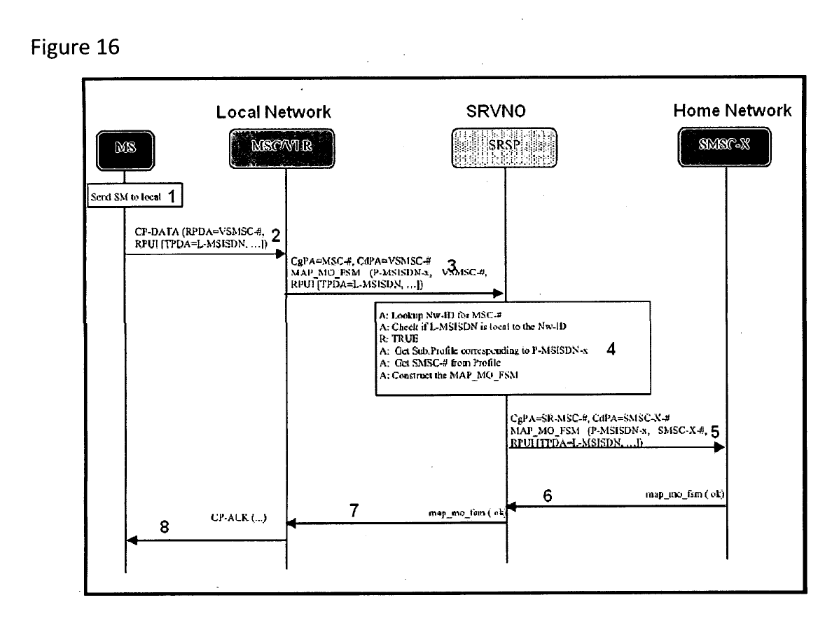

The present invention, in at least some embodiments, also provides process flows for virtual roaming that enable a mobile device to send a SMS message from outside of the home network, through the local network, as described with regard to illustrative FIGS. 15 and 16. Again, as for the above Figures that describe exemplary process flows for enabling the mobile device to receive SMS messages, the messages are preferably passed through the SRVNO.

FIG. 15 describes an exemplary, illustrative process flow for sending a SMS message by the mobile device to an international MSISDN (ie, an MSISDN that is not part of the local network, but not necessarily in a different country or region) while in contact with the local network. In stage 1, the mobile device (MS) prepares an SMS message, which in stage 2 is sent to the international MSISDN. In stage 3, the MSC/VLR of the local network receives the SMS message and sends it to the SRVNO. In stage 4, the SRVNO determines that the MSISDN is not part of the local network. In stage 5, the message is passed to the SR-SMSC, along with the originating local MSISDN and the intended recipient international MSISDN. The SR-SMSC then passes the message to the network of the international MSISDN (not shown). In stages 6-8, acknowledgements are transmitted to the mobile device through the local network and the SRVNO as shown.

FIG. 16 describes an exemplary, illustrative process flow for sending a SMS message by the mobile device to a local network MSISDN while in contact with the local network. In stage 1, the mobile device (MS) prepares an SMS message which is sent to the local network MSISDN in stage 2. In stage 3, the MSC/VLR of the local network receives the SMS message and sends it to the SRVNO. In stage 4, the SRVNO determines the identity of the home network SMSC. In stage 5, the message is passed to the home network SMSC, along with the originating local MSISDN and the intended recipient local network MSISDN. The home network SMSC then passes the message to the local network MSISDN (not shown). In stages 6-8, acknowledgements are transmitted to the mobile device through the local network and the SRVNO as shown.

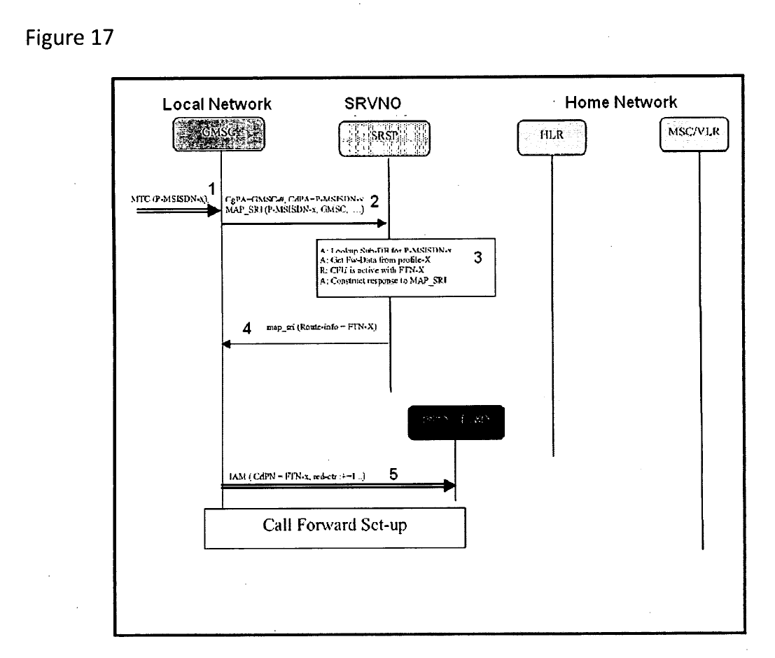

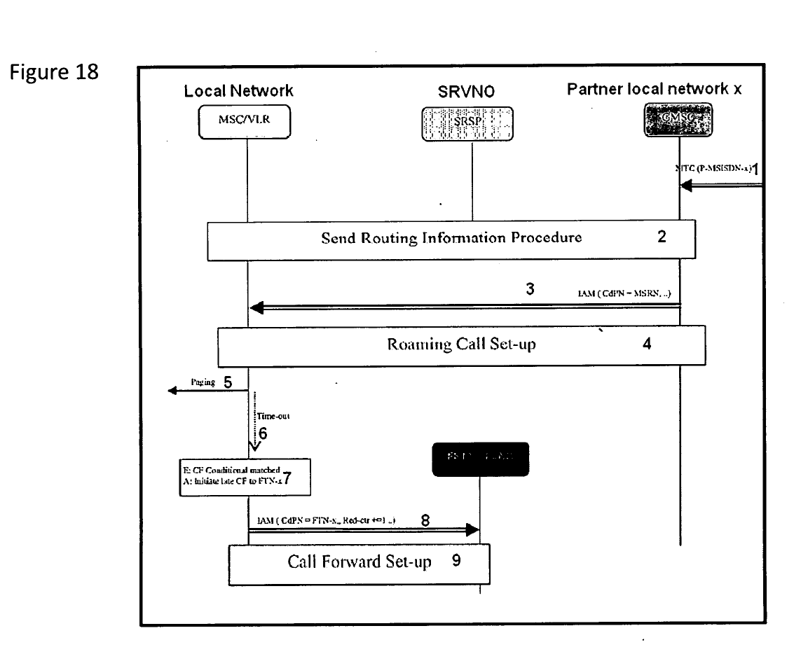

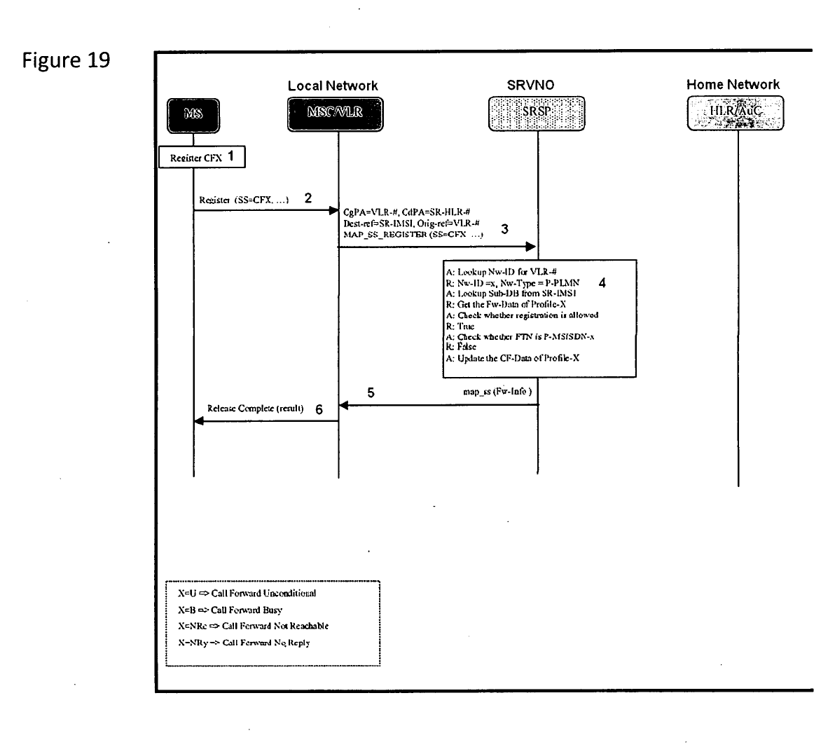

Call forwarding is another optional feature that is supported by at least some embodiments of the present invention. By “call forwarding” it is meant that telephonic communication intended for the mobile device is instead transferred to another MSISDN, usually of another device. The MSISDN may optionally be associated with a fixed line telephone system or PSTN (public switched telephone network) and/or with a mobile network. FIGS. 17 and 18 relate to illustrative flows for two different exemplary types of call forwarding, while FIG. 19 illustrates an exemplary flow for activating call forwarding from outside of the home network by the mobile device.

FIG. 17 shows an illustrative exemplary flow according to some embodiments of the present invention for an early call forwarding process. By “early” it is meant that the call forwarding process does not involve roaming. In stage 1, a telephone call is made to the local network MSISDN of the mobile device and the request is sent to the GMSC of the local network. The GMSC of the local network recognizes that the local network MSISDN is associated with the SRNVO and so transfers the relevant information in stage 2. In stage 3, the SRVNO performs a data look-up as previously described, and determines that the call is to be forwarded to a different telephone number. This information is sent to the GMSC of the local network in stage 4, which then forwards the call in stage 5 to the relevant mobile network or PSTN, as required. The call is therefore connected through call forwarding.

FIG. 18 shows an illustrative exemplary flow according to some embodiments of the present invention for a late call forwarding process. By “late” it is meant that the call forwarding process involves roaming. In stage 1, a telephone call is made to the local network MSISDN of the mobile device and the request is sent to the GMSC of the local network (which is associated with the SRVNO and hence is described as a “partner local network” for the purpose of description only and without any intention of being limiting). The GMSC of the local network recognizes that the local network MSISDN is associated with the SRNVO and so transfers the relevant information in stage 2. Now the previously described call set-up process according to at least some embodiments of the present invention is performed, for example as with regard to the above Figures, to the network that will receive the forwarded call. In stage 3, the GMSC of the local network connects to the relevant entity or entities in the network to which the mobile device is connected (for example, the MSC/VLR for a GSM mobile network). It should be noted that this network may optionally be the home network for the mobile device, or another network through which the mobile device is currently communicating.

A virtual roaming call is then set up in stage 4 as previously described. The mobile device is paged in stage 5; stage 6 is a time out period. The MSC/VLR of the network to which the mobile device is connected then determines that the call is to be forwarded in stage 7, and so forwards the call in stage 8 to the relevant mobile network or PSTN, as required. In stage 9, the call is connected through call forwarding.

FIG. 19 illustrates an exemplary flow for activating call forwarding from outside of the home network by the mobile device. As shown, in stage 1 the mobile device (MS) requests call forwarding through the local network to which the MS is currently in communication. This request is sent to the local network in stage 2 and to the SRVNO in stage 3, which performs a look-up as previously described to identify the mobile device according to the SR-IMSI in stage 4. The SRVNO determines whether call forwarding is permitted for the device according to the user profile, preferably including information in the database. In stage 5, if permitted, the forwarding information and permission for forwarding is sent to the local network, which acknowledges to the mobile device in stage 6.

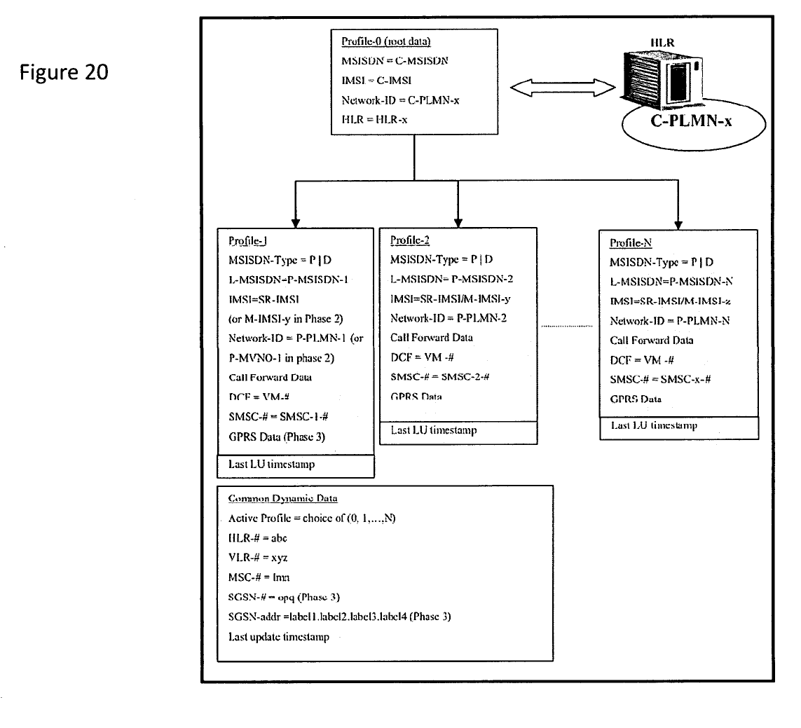

FIG. 20 relates to an exemplary data structure for the user profile information, which is preferably stored at the SR-HLR. The user profile information preferably supports multiple user profiles. A root data profile 0, which is related to the home network user profile (and for this reason is shown as being logically connected to the HLR of the home network), preferably includes the home network MSISDN, the home network IMSI, the identification of the home network and the identification of the home network HLR (ie the home network HLR number). The root profile is shown as being connected to one or more user profiles 1 . . . N, of which three are shown for the purposes of illustration only and without any intention of being limiting.

For example and without limitation, user profile 1 is shown as including a local network MSISDN (and whether the local MSISDN is fixed or temporary), the SR-IMSI, the identification of the particular local network associated with this profile, any call forwarding data if applicable, the identification of the local network SMSC and any other relevant information, optionally including a timestamp for the last update of this information. Similarly, user profile 2 includes such information but for a different local network, and so forth through user profile N. Common dynamic data which may optionally and preferably be shared between the user profiles may optionally include but is not limited to the identification of which user profile is currently active (from any of user profiles 0 . . . N), the current identifiers for the currently relevant HLR, VLR, MSC and SGSN, and also the last update timestamp for this current information.

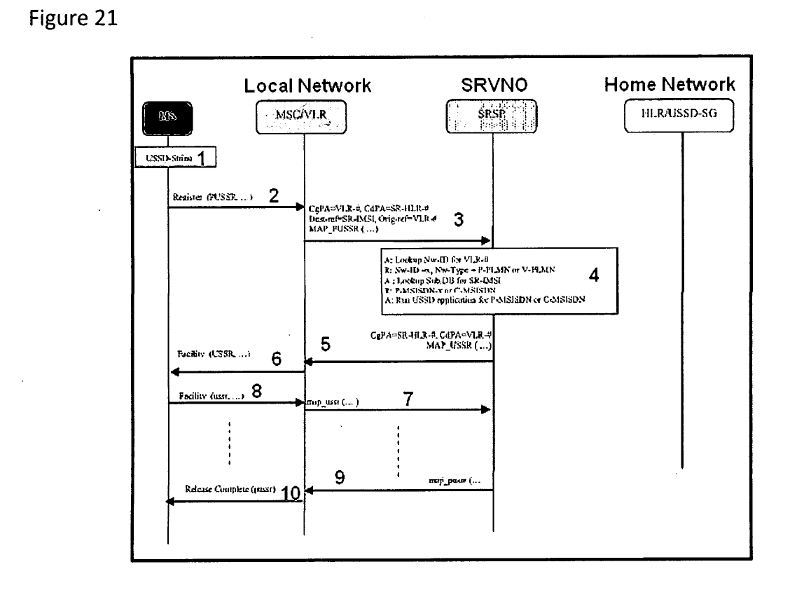

FIG. 21 relates to provision of USSD (Unstructured Supplementary Service Data) when the mobile device is communicating through the local network. USSD is used to send short text messages but is session oriented, such that the text is only available during the session. It can be used for mobile chat or other instant messaging applications, as the text messages cannot be stored for later retrieval (unlike SMS messages, for example). In some embodiments, the present invention supports such USSD sessions.

In stage 1, the mobile device initiates a USSD session by registering with the local network in stage 2. In stage 3, the local network recognizes that the mobile device is associated with an SR-IMSI, and hence is associated with the SRVNO. This information is passed to the SRNVO (and more specifically to the SR-HLR). In stage 4, the SRVNO determines whether the mobile device is associated with the local network MSISDN or with the home network MSISDN, as well as identifies the recipient device. In stage 5, the requisite information is sent to the local network by SR-HLR, which determines which action is to be taken with the information. The local network passes it to the mobile device to start transferring information during the session in stage 6 according to the instructions sent by the SR-HLR. Stages 7 and 8 relate to data transfer during the session. At some point, the session is ended (shown in stage 9) and the mobile device is released from the session by the local network in stage 10.

According to some embodiments of the present invention, there is provided a process for transfer of data through the mobile device by smart roaming. The mobile device preferably first registers at a SRVNO partner network (ie SRVNO associated local network) with the SR-IMSI according to the usual SRVNO registration flow as described herein.

Upon registration, the mobile device may optionally establish a data session using the local network SGSN (serving GPRS support node) signal to the SR-HLR for service authorization. GPRS (general packet radio services) is the protocol for transmitting packets according to IP for GSM mobile networks. The SR-HLR relays data service authorization to the home network HLR, and relays back the authorization confirm to the local network SGSN.

The data session is then established, for transmitting data packets according to IP, and can enable the voice over mobile data service for example. Once the data session is established, it proceeds as is known in the art.

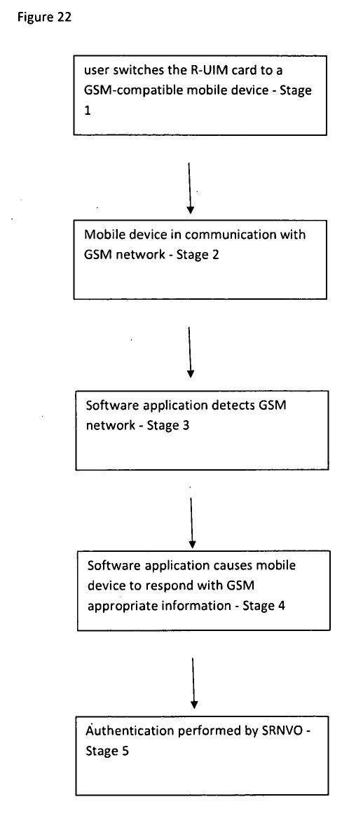

In some cases, the mobile device may optionally not feature a SIM card as described above, but may instead feature a similar card for CDMA (Code Division Multiple Access) telephones. This card is known as a R-UIM (Re-Useable Identification Module). In order for the CDMA mobile device to be able to virtually roam in a GSM system (or other compatible system) as described above, the R-UIM is preferably equipped with a SR-IMSI and the above described software application (and user profile), which allows the card to be recognized by a GSM network and hence the SRVNO (SR-HLR) as described above. However, the card would still need to be switched into a GSM-compatible handset for communication through the GSM network to occur. To support communication with a GSM network, the R-UIM card preferably includes more information, and more preferably includes all of the necessary information that would normally appear on a SIM card. A flowchart of this method is described with regard to FIG. 22.

As shown, in stage one, the user switches the R-UIM card to a GSM-compatible mobile device. In stage two, the mobile device is placed in communication with a GSM network. In stage three, the software application on the card detects that a GSM network is requesting information. In stage four, the software application causes the card to respond with GSM-required and compatible information, such that the card appears to be a regular SIM card. Preferably, this information includes the SR-IMSI and the Ki as previously described. The rest of the process preferably continues as described previously. However, since the home network is a CDMA network which would not be able to authenticate the mobile device, in stage five authentication is preferably performed by the SRVNO.

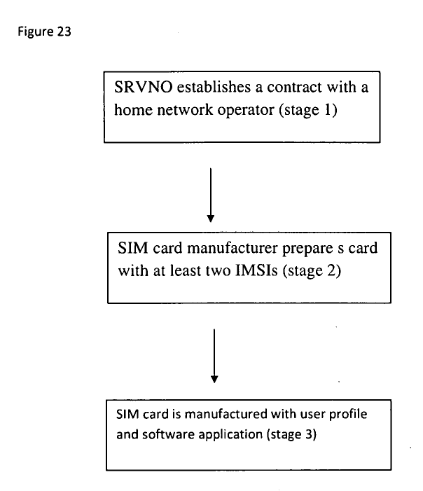

FIG. 23 relates to a method for SIM card manufacture according to some embodiments of the present invention. Such a method could also optionally be adapted for R-UIM manufacture.

In stage 1, the SRVNO establishes a contract with a home network operator as previously described. In stage 2, a SIM card manufacturer is instructed to prepare the SIM card with at least two IMSIs as previously described, one of which is related to the SRVNO and one of which is related to the home network operator. However, preferably only one Ki is provided, to be shared between the SRVNO and the home network operator. In stage 3, the SIM card is manufactured with the user profile and also the necessary software application as determined by the SRVNO. Optionally, multiple such IMSIs and user profiles could be provided on the SIM card if desired.

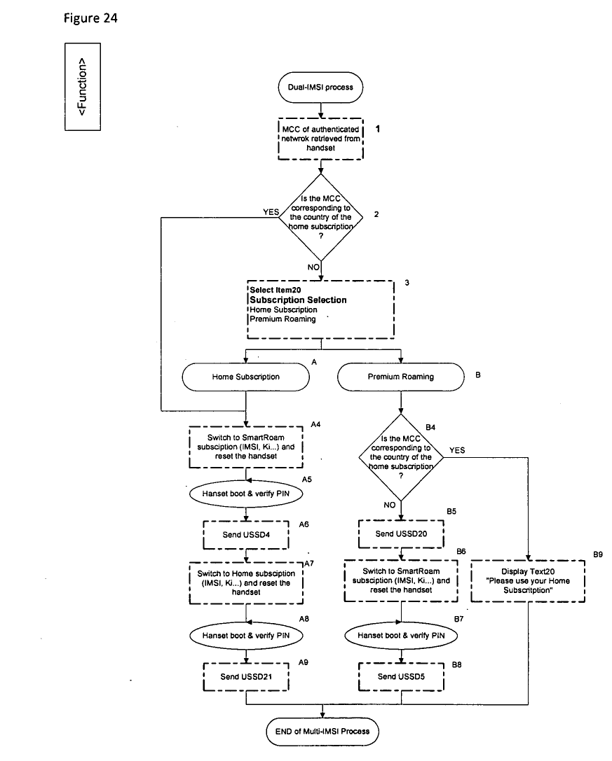

FIG. 24 relates to a flowchart for implementation of smart roaming through the use of the SIM card according to some non-limiting embodiments of the present invention. As shown, in stage 1, the MCC of the authenticated network is retrieved from the mobile device. In stage 2, the software application on the SIM card preferably determines whether the MCC corresponds to the country of the home network of the mobile device. If yes, then the process proceeds directly to flow “A”. If not, then in stage 3, a subscription selection process is performed, to determine the type of subscription associated with the MCC, for example, or according to other parameters. For the home network subscription, the process continues with flow “A”; for roaming (shown herein as premium roaming as a non-limiting example only), the process continues with flow “B”.

Turning now to flow “A”, in stage 4A the SIM card application preferably causes the mobile device to switch to the smart roaming process as described above and resets the device. In stage 5A, the mobile device is preferably rebooted and the PIN (identifier) optionally verified, if desired. In stage 6A, notification is sent through USSD. In stage 7A, the mobile device is preferably switched back to the home subscription network, upon re-entering the home network. In stage 8A the device is preferably rebooted with PIN reset as described above. In stage 9A, notification is again sent through USSD.

Turning now to flow “B”, in stage 4B again it is checked whether the MCC corresponds to the country of the home network. In stage 5B, a USSD notification is sent. In stage 6B, the SIM card application preferably causes the mobile device to switch to the smart roaming process as described above and resets the device. In stage 7B, the mobile device is preferably rebooted and the PIN (identifier) optionally verified, if desired. In stage 8B, notification is sent through USSD.

If the MCC does correspond to the country of the home network, then in stage 9B, preferably text is displayed indicating that the home subscription is to be used.

While the invention has been described with respect to a limited number of embodiments, it will be appreciated that many variations, modifications and other applications of the invention may be made.

What is claimed is:

1. A method for virtual roaming of a mobile device between a local mobile network and a home mobile network, wherein the mobile device features a SIM card for communication with each of the local mobile network and home mobile network, and wherein the mobile device is associated with a subscription to the home mobile network, the method comprising:
Initiating communication between the mobile device and the local mobile network;
Transmitting a first IMSI from the SIM card to the local mobile network by the mobile device;
Identifying the home mobile network according to said first IMSI;
Transmitting a second IMSI and a Ki;
Receiving said second IMSI and said Ki by the home mobile network;
Authenticating the mobile device according to said second IMSI and said Ki by the home mobile network; and
Associating said first IMSI of the mobile device with a local network MSISIDN of the local mobile network, such that the mobile device receives and/or performs telephonic communication directed to said local network MSISIDN.

2. The method of claim 1, further comprising providing a SRVNO (smart roaming virtual network operator) in communication with the local mobile network and with the home mobile network, wherein said transmitting said first IMSI further comprises also transmitting said Ki from said SIM card, wherein said identifying the home mobile network according to said first IMSI is performed by said SRNVO and wherein said transmitting said second IMSI and said Ki further comprises transmitting said second IMSI and said Ki by said SRVNO to the home mobile network.

3. The method of claim 2, further comprising performing telephonic communication with the mobile device through said local network MSISIDN, wherein upon authentication of the mobile device, said telephonic communication does not require said SRVNO.

4. The method of claim 3, wherein said SRNVO is in communication with the physical infrastructure of an actual mobile network operator and wherein said SRVNO comprises at least a separate SR-HLR, such that said SR-HLR is different from an HLR of said actual mobile network operator, wherein said SR-HLR identifies the home mobile network according to said first IMSI.

5. The method of claim 4, wherein said SR-HLR also determines said second IMSI according to said first IMSI, for transmission to the home mobile network.

6. The method of claim 5, wherein said local network MSISIDN is temporarily assigned to said first IMSI.

7. The method of claim 6, wherein said associating said first IMSI of the mobile device with said local network MSISIDN of the local mobile network is performed by said SR-HLR.

8. The method of claim 7, wherein said local network MSISIDN is assigned to said first IMSI after the mobile device ceases to be in contact with the local mobile network for a predetermined period of time.

9. The method of claim 5, wherein said local network MSISIDN is permanently assigned to said first IMSI.

10. The method of claim 5, wherein said local network MSISIDN is associated with said first IMSI before said initiating said communication between the mobile device and the local mobile network.

11. The method of claim 5, wherein all IMSIs on the SIM card are associated with a single Ki of the home mobile network.

12. The method of claim 11, wherein the SIM card further comprises a software application for selecting an IMSI to be transmitted upon initiating communication with a mobile network, such that if said mobile network is the local mobile network then said first IMSI is sent and such that if said mobile network is the home mobile network then said second IMSI is sent from the SIM card.

13. The method of claim 12, wherein said initiating said communication between the mobile device and the local mobile network further comprises determining that the mobile device is in a new location according to a location area code (LAC); and requesting a location update by the mobile device to the local mobile network.

14. The method of claim 13, wherein said second IMSI is associated with a home network MSISDN, the method further comprising: receiving a request for telephonic communication to said home network MSISDN by the home mobile network; relaying said request to said SRVNO; determining a current network location of the mobile device by said SR-HLR; and connecting the mobile device to the home mobile network directly from the local mobile network for communication, without passing said communication through said SRNVO after authentication.

15. The method of claim 13, further comprising: receiving a request for telephonic communication to said local network MSISDN by the local mobile network; relaying said request to said SRVNO; determining a current network location of the mobile device by said SR-HLR; and connecting the mobile device directly to the local mobile network for communication, without passing said communication through said SRNVO after authentication.

16. The method of claim 13, further comprising ceasing communication with the local mobile network by the mobile device; initiating communication with the home mobile network at a physical location having service provided by the home mobile network by the mobile device; and updating said SR-HLR to indicate a current location of the mobile device at the home mobile network.

17. The method of claim 2, wherein said telephonic communication comprises an SMS (short message service) message, the method further comprising: transmitting said SMS message to said local network MSISDN; receiving said SMS message by a SMSC at the local mobile network; transmitting said SMS message to said SRVNO; and passing said SMS message from said SRVNO to the mobile device.

18. The method of 2, wherein said telephonic communication comprises an SMS (short message service) message and wherein said second IMSI is associated with a home network MSISDN, the method further comprising: transmitting said SMS message to said home network MSISDN; receiving said SMS message by a SMSC at the home mobile network; determining a current location of the mobile device as being outside of the home mobile network; transmitting said SMS message to said SRVNO; and passing said SMS message from said SRVNO to the mobile device.

19. The method of claim 2, wherein said second IMSI is associated with a home network MSISDN, the method further comprising: receiving a request for telephonic communication to said local network MSISDN by the local mobile network; relaying said request to said SRVNO; determining by said SR-HLR that said telephonic communication associated with said local network MSISDN is to be forwarded to a telephone number other than said home network MSISDN or said local network MSISDN; and connecting the mobile device directly to a network associated with said other telephone number for communication, without passing said communication through said SRNVO after authentication.

20. The method of claim 19, wherein said network associated with said other telephone number comprises a PSTN.

21. The method of claim 19, wherein said network associated with said other telephone number comprises a mobile network.

22. The method of claim 19, wherein said connecting the mobile device directly to said network associated with said other telephone number comprises initiating roaming between the home mobile network and the local mobile network before call forwarding.

23. The method of claim 19, wherein said connecting the mobile device directly to said network associated with said other telephone number is performed without roaming between the home mobile network and the local mobile network.

24. The method of claim 2, wherein said telephonic communication comprises a USSD session, the method further comprising requesting said USSD session by the mobile device through the local network; and determining a correct address for connecting said USSD session by said SRVNO.
